(19) United States
(12) Patent Application Publication
(10) Pub. No.: US 2008/0043881 A1
(43) Pub. Date: Feb. 21, 2008

(54) System for calibrating at least one quadrature modulator and operating method therefor

(76) Inventor: Reiner Franke, Velbert (DE)

Correspondence Address: MG-IP Law, PLLC, P.O. BOX 1364, FAIRFAX, VA, 22038-1364, US

(21) Appl. No.: 11/812,097

(22) Filed: Jun. 14, 2007

Related U.S. Application Data
(60) Provisional application No. 60/819,386, filed on Jul. 10, 2006.

(30) Foreign Application Priority Data
Jun. 14, 2006 (DE) DE10 2006 027 557

(51) Int. Cl. H04L 27/36

(52) U.S. Cl. 375/298

(57) ABSTRACT

A system for calibrating at least one quadrature modulator is provided that includes a first correction device connectable ahead of the quadrature modulator on the input side, for converting a complex input signal into a corrected complex input signal, a feedback branch, which is connectable to an output of the quadrature modulator and has an amplitude detector. A test signal generator, connectable ahead of the correction device on the input side, is provided for providing predetermined test signals, and the feedback branch has a filter, particularly a bandpass filter.

This nonprovisional application claims priority to German Patent Application No. DE 102006027557, which was filed in Germany on Jun. 14, 2006, and to U.S. Provisional Application No. 60/819,386, which was filed on Jul. 10, 2006, and which are both herein incorporated by reference.

### BACKGROUND OF THE INVENTION

1. Field of the Invention

The present invention relates to a system for calibrating at least one quadrature modulator, with a first correction device, connectable ahead of the quadrature modulator on the input side, for converting a complex input signal into a corrected complex input signal, and with a feedback branch, which is connectable to an output of the quadrature modulator and has an amplitude detector.

Furthermore, the present invention relates to a method for operating a system for calibrating at least one quadrature modulator with a correction device, connectable ahead of the quadrature modulator on the input side, for converting a complex input signal into a corrected complex input signal, whereby the quadrature modulator in a first adjustment process is not supplied with an input signal, and whereby during the first adjustment process at least one parameter of a first correction unit, provided in the correction device, for correcting an offset of at least one component of the complex input signal is set so that an envelope signal, detected by an amplitude detector, of the quadrature signal outputted by the quadrature modulator at its output falls below a predetermined threshold value.

2. Description of the Background Art

Systems and methods of the aforementioned type are used, for example, in transmitting devices, in which the effects of crosstalk of signals from a local oscillator, assigned to the quadrature modulator, on the wanted signals, supplied by the quadrature modulator, or the corresponding inputs of the quadrature modulator are to be reduced. This effect, which is also known as local oscillator leakage, has the result that a carrier signal with a not negligible amplitude is received at an output of the quadrature modulator, because the local oscillator signal is supplied both via a mixed frequency input, provided herefor, of the quadrature modulator and via the signal inputs, actually provided for the wanted signals, of the quadrature modulator.

A known approach for compensating the local oscillator leakage effect is an offset correction of the wanted signals present in the form of complex input signals, as may occur, for example, by addition of a parameter to at least one component of the complex input signal. The parameters are selected hereby in such a way that an envelope signal, determined by an amplitude detector, of the quadrature signal, outputted by the quadrature modulator at its output, falls below a predetermined threshold value.

### SUMMARY OF THE INVENTION

It is therefore an object of the present invention to provide a system and an operating method of the aforementioned type to the effect that a more flexible and improved calibration of at least the quadrature modulator is possible.

This object is achieved according to the invention in that a test signal generator, connectable ahead of the correction device on the input side, is provided for providing predetermined test signals and that the feedback branch has filtering means, for example, a bandpass filter.

The test signal generator provided according to the invention makes it possible to supply the correction device with test signals with known properties, which are assigned corresponding known quadrature signals or envelope signals derived therefrom by the amplitude detector, so that adjustment of the quadrature modulator is possible by a comparison of ideally expected envelope signals with the actually received envelope signals.

In an especially advantageous manner, the filtering means provided in the feedback branch make it possible to evaluate a special frequency range of the considered envelope signal. It is thereby possible to adjust the quadrature modulator in regard to this specially considered frequency range, i.e., to calibrate the quadrature modulator especially with respect to this frequency range.

Thus, the calibration system of the invention makes possible a selective optimization of an operation of the quadrature modulator, for example, with respect to the suppression of unwanted modulation products, which occur in certain frequency ranges, e.g., related to a frequency of the test signal.

In an embodiment of the system of the invention, at least one additional feedback branch, connectable to the output of the quadrature modulator, is provided, the branch which has an amplitude detector and/or filtering means. This advantageously provides the opportunity, for example, to evaluate simultaneously an unfiltered envelope signal and a filtered envelope signal or also envelope signals filtered in different ways. For example, modulation products of different frequency ranges can be determined selectively in this way by different feedback branches and, for example, be reduced or even eliminated by suitable setting of the correction device.

In another embodiment of the system of the invention, the filtering means are switchable as desired into or out of the feedback branch; i.e., a feedback branch can be formed by this means which, depending on the switching states of the switches used for this purpose, has or does not have an assigned filter. This type of feedback branch, depending on the switching state of the employed switch, enables the formation of an unfiltered envelope signal and a filtered envelope signal.

The amplitude detector can be advantageously designed as a logarithmic amplitude detector especially in the feedback branches to which no filtering means is assigned, which results in a greater dynamic range in regard to the signals processable by the feedback branch.

In another aspect of the invention, a control unit is provided to evaluate feedback signals obtained by means of the feedback branch (branches). The control unit can be realized by a state machine, i.e., for example, in the form of discrete logic elements, or also by a microcontroller or the like, and is used particularly to evaluate the feedback signals and to control the operation of the system of the invention or to carry out the method of the invention.

Another aspect of the invention is characterized by the provision of a second correction device whose input is connectable to an output of a quadrature demodulator and whose output is connectable to a filtering means assigned to a quadrature demodulator and which is provided for converting a complex output signal of the quadrature modulator into a corrected complex output signal.

This variant of the invention can be integrated especially advantageously, for example, into a combined transmitter/receiver, also called a transceiver, and permits, in addition to the calibration of the quadrature modulator, by virtue of the second correction device according to the invention, also a calibration of a quadrature demodulator provided in the receiving branch of the transceiver.

An output of the filtering means, assigned to the quadrature demodulator, can be connected especially advantageously to one of the feedback branches. This provides the possibility of using components, present in the feedback branches, such as, for example, amplitude detectors or filtering means, both for calibrating the quadrature modulator and for calibrating the quadrature demodulator, which results in especially efficient utilization of these components. The second correction unit assigned to the quadrature demodulator can be connected on the output side also directly to one of the feedback branches to make possible the evaluation of the corrected complex output signal by the feedback branch.

Multiple utilization of the components present in the feedback branches is especially simplified in the inventive manner by at least one multiplexer provided in one of the feedback branches. This type of multiplexer can connect, for example, as desired an output of an amplitude detector or filter of the respective feedback branch or the output of the filtering means, assigned to the quadrature demodulator, or the second correction unit to an additional amplitude detector of the feedback branch. In general, this type of multiplexer can be used in a manner known per se to select different input signals of an amplitude detector or a filter.

The additional amplitude detector on the output side of the multiplexer is also designed especially advantageously as a logarithmic detector.

It may be provided according to the invention that the first and/or second correction device has a first correction unit for correcting an offset of at least one component of the complex input signal or output signal. By means of this type of offset correction, for example, asymmetries with respect to the peak values of the signal components of a local oscillator signal employed in the quadrature modulator or in the quadrature demodulator for modulation or demodulation, respectively, can be eliminated, as a result of which, for example, the local oscillator leakage effect is reduced.

Another embodiment of the system of the invention provides that the first and/or second correction device has a second correction unit for influencing a phase and/or amplitude of the complex input signal or output signal. The second correction device accordingly makes possible correction of the complex signal, which can occur, for example, in the form of a rotation, extension, or also combined rotation/extension of a signal value, to be detected as a complex number, of the complex signal.

According to another embodiment of the system of the invention, it is advantageous for parameters of the first and/or second correction device to be settable by the control unit, whereby the setting of the parameters preferably occurs as a function of the feedback signals, which can be determined by the feedback branch (branches). The construction of a control loop is possible thereby in order to compensate errors, occurring due to nonideal conditions, during the signal processing such as, for example, the quadrature modulation and the like.

A further increase in precision during the calibration of components using the system of the invention can be achieved in that filtering means are provided for filtering the test signals provided by the test signal generator. Said filtering means limit the frequency range of the test signals, provided by the test signal generator, according to their parameters and therefore compensate possible tolerances in the test signals, provided by the test signal generator, or the test signal generator.

The operating method of the invention is characterized by a second adjustment process, which follows the first adjustment process for offset calibration and which comprises the steps of: outputting of a test signal with a predetermined first frequency or center frequency by a test signal generator as a complex input signal to the correction device; determination of an envelope signal of the quadrature signal, produced from the test signal, by an amplitude detector, which is provided in a feedback branch connectable to the output of the quadrature modulator; filtering of the determined envelope signal; evaluation of the filtered envelope signal by a control unit; and setting of at least one parameter of a second correction unit, provided in the correction device, for influencing a phase and/or amplitude of the complex input signal so that the filtered envelope signal falls below a predetermined threshold value.

The operating method of the invention is especially well suited for calibration of a quadrature modulator with respect to a best possible image frequency suppression during processing of a bandpass signal supplied to it as an input signal. Signals of this type are processed, for example, in transceivers, which operate in an intermediate frequency range with relatively low frequencies (near zero intermediate frequency).

During the modulation of a bandpass signal of this type supplied to the quadrature modulator on the input side, for example, because of asymmetries relative to the quadrature modulator components, processing the individual signal components, it can occur that an actually received quadrature signal at the output of the quadrature modulator also receives another unwanted frequency band in addition to the first wanted frequency band, which corresponds to the bandpass signal shifted by the local oscillator frequency of the quadrature modulator on the frequency axis.

This type of unwanted frequency band is detected by the determination of an envelope signal according to the invention and the subsequent filtering of the envelope signal, as well as an evaluation of the filtered envelope signal by the control unit. Furthermore, by suitable selection or setting of parameters of the second correction unit, the complex input signal can be predistorted so that the actually present asymmetries in the quadrature modulator and other interfering effects act on the process of quadrature modulation only in a weakened manner or are even completely eliminated. It is thereby possible to suppress selectively unwanted frequency bands in the quadrature signal.

The filtering of the envelope signal can include a bandpass filter, whereby a center frequency is selected for the bandpass filtering, which, for instance, is within the range of the double frequency or the center frequency of the employed test signal.

In a determination of the envelope signal of the quadrature signal formed from the test signal, in addition to a carrier signal, which originates substantially from the wanted frequency band of the quadrature-modulated signal, also a bandpass signal, unwanted per se, is received, which originates substantially from the bandpass signal, unwanted per se, of the quadrature-modulated signal. Because this is especially an image frequency of the quadrature-modulated signal, the unwanted bandpass signal of the envelope signal has a center frequency that corresponds approximately to double the frequency or center frequency of the test signal. Only the spectral portion of the envelope signal that originates from the unwanted second frequency band of the quadrature-modulated signal is selected preferably by the aforementioned bandpass filtering of the invention. Other, likewise unwanted signal parts, such as, e.g., noise or other in principle likewise interfering modulation products, are excluded advantageously thereby from the calibration process of the invention; as a result, a more precise calibration of the quadrature modulator is possible particularly in regard to the suppression of the second frequency band, unwanted per se, or the image frequency.

In another embodiment of the method of the invention, it is provided that during the second adjustment process, preferably several test signals are outputted one after another, each with a different frequency or center frequency, and that a corresponding set of parameters is determined for each frequency. Both the offset correction and the calibration in regard to the suppression of unwanted frequency bands such as, for example, image frequencies, are thereby possible according to the present invention for several different operating frequency ranges. For example, communication systems, which alternately use an upper or lower sideband for data transmission, can be calibrated with respect to both sidebands in such a way that they each have optimal suppression of the unused other sideband during quadrature modulation.

Another embodiment of the method of the invention is characterized by an additional adjustment process with the process steps of: supplying the quadrature signal formed from the test signal to a quadrature demodulator, whereby a demodulated test signal is received as an output signal at an output of the quadrature demodulator; formation of a corrected demodulated test signal by a second correction unit, assigned to the quadrature demodulator, for influencing a phase and/or amplitude of the demodulated test signal; determination of an envelope signal of the corrected demodulated test signal by an amplitude detector; evaluation of the determined envelope signal by the control unit; and setting of at least one parameter of the second correction unit so that the determined envelope signal falls below a predetermined threshold value.

In an especially advantageous manner, the aforementioned additional adjustment process is performed after a successful adjustment or after a successful calibration of the system of the invention in regard to the quadrature modulator. In this case, it is assured that the quadrature signal, formed by the quadrature modulator from the test signal supplied to it, has only minimal distortions or asymmetries, for example, in the form of an unwanted sideband.

This type of quadrature signal is supplied to the quadrature demodulator on the input side according to the invention, for example, via a switchable connection, whereupon a demodulated test signal is received at an output of the quadrature demodulator as an output signal. The quadrature demodulator is advantageously followed by a second correction unit, which forms a corrected demodulated test signal from the demodulated test signal. The formation of the corrected demodulated test signals occurs in the same way as already provided with respect to the second correction unit, which is assigned to the quadrature modulator.

Accordingly, in a similar manner, an envelope signal, which is evaluated by the control unit of the system of the invention, is determined also for the corrected demodulated test signal, from which, for example, conclusions can be drawn on a non-optimal quadrature demodulation by the quadrature demodulator. In this case, at least one parameter of the second correction unit can be adjusted or changed by the control unit so that the determined envelope signal corresponds to the specifications to be achieved or is minimized in the case of an unwanted frequency band.

In another aspect of the method of the invention, alternatively, a filtered envelope signal of the quadrature modulator or the corrected demodulated test signal of the quadrature demodulator is supplied to the control unit by a multiplexer provided in the feedback branch. The output signal of the multiplexer is advantageously supplied to a preferably logarithmic amplitude detector, in order to obtain therefrom a feedback signal for evaluation by the control unit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic block diagram of a first embodiment of the calibration system of the invention,

FIG. 2 a detailed view of the calibration system of FIG. 1,

FIG. 3 is a simplified spectral presentation of signals processed by the calibration system, and

FIG. 4 is a flow chart of an embodiment of the method of the invention.

### DETAILED DESCRIPTION

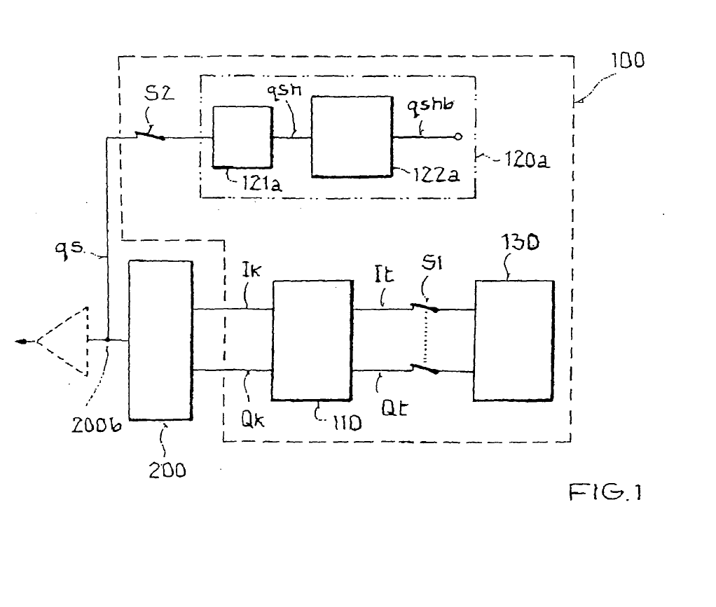

The simplified block diagram according to FIG. 1 shows a first embodiment of the calibration system 100 of the invention for calibrating a quadrature modulator 200. The components of the calibration system 100 of the invention are surrounded by a broken line, whereas quadrature modulator 200 itself and an amplifier downstream of it are not part of the calibration system 100 of the invention and can be connected to said system, for example, via switchable connections (not shown).

Calibration system 100 of the invention has a test signal generator 130, which outputs known test signals at its output that have an in-phase component It and a quadrature component Qt. Calibration system 100 of the invention furthermore has a first correction device 110, which converts a complex input signal, supplied to it at the input side, into a corrected complex input signal Ik, Qk. Provided that test signal generator 130 of the invention, as shown in FIG. 1, is connected to the input of first correction device 110, correction device 110 accordingly converts test signals It, Qt into corrected test signals Ik, Qk.

For normal operation of quadrature modulator 200, which is performed outside the calibration of the invention, switch S1, located between test signal generator 130 and correction device 110, is opened, so that henceforth test signals It, Qt are no longer applied at the input of correction device 110, but input signals I, Q (not shown in FIG. 1) which are, for example, a wanted signal present in complex form.

During normal operation, furthermore, the quadrature signal qs, made available by quadrature modulator 200 at its output 200b is outputted to the subsequent power amplifier (not specified more closely), which can be supplied after appropriate amplification, for example, to an antenna system not shown in FIG. 1.

During normal operation, second switch S2 is also opened, which is assigned to a feedback branch 120a, as shown by the dash-dot line, of calibration system 100 of the invention, and which connects said system during the calibration of the invention to output 200b of quadrature modulator 200. This state is shown in FIG. 1.

Feedback branch 120a has an amplitude detector 121a, which performs an envelope modulation of the quadrature signal qs supplied to it via switch S2, as a result of which an envelope signal qsh of the quadrature signal qs is received at an output of amplitude detector 121a. The envelope signal qsh is supplied to filter 122a, which is also arranged in feedback branch 120a according to the invention and which preferably is a bandpass filter. After suitable bandpass filtering of the envelope signal qsh, a bandpass-filtered envelope signal qshb is available at the output of bandpass filter 122a.

The bandpass-filtered envelope signal qshb is utilized according to the invention to detect selectively unwanted signal parts of the quadrature signal qs, arising due to asymmetries in quadrature modulator 200 and other disturbances and by adaptation of parameters of correction device 110 to effect a distortion of the complex signal Ik, Qk, supplied to quadrature modulator 200, which results in compensation of unwanted signal portions in the quadrature signal qs.

The filtering of the invention by filter 122a hereby advantageously permits a selective optimization of the distortion effected by correction device 110 with respect to certain frequency portions of the quadrature signal qs.

A control of the calibration process of the invention and the setting of the parameters of correction device 110 can be performed, for example, by a control unit already present and assigned to quadrature modulator 200, which is not shown in FIG. 1. For example, the bandpass-filtered envelope signal qshb can be supplied to this type of control unit, and the control unit can control via appropriate control lines (not shown in FIG. 1) the state of switches S1, S2 and influence the parameters of first correction device 110.

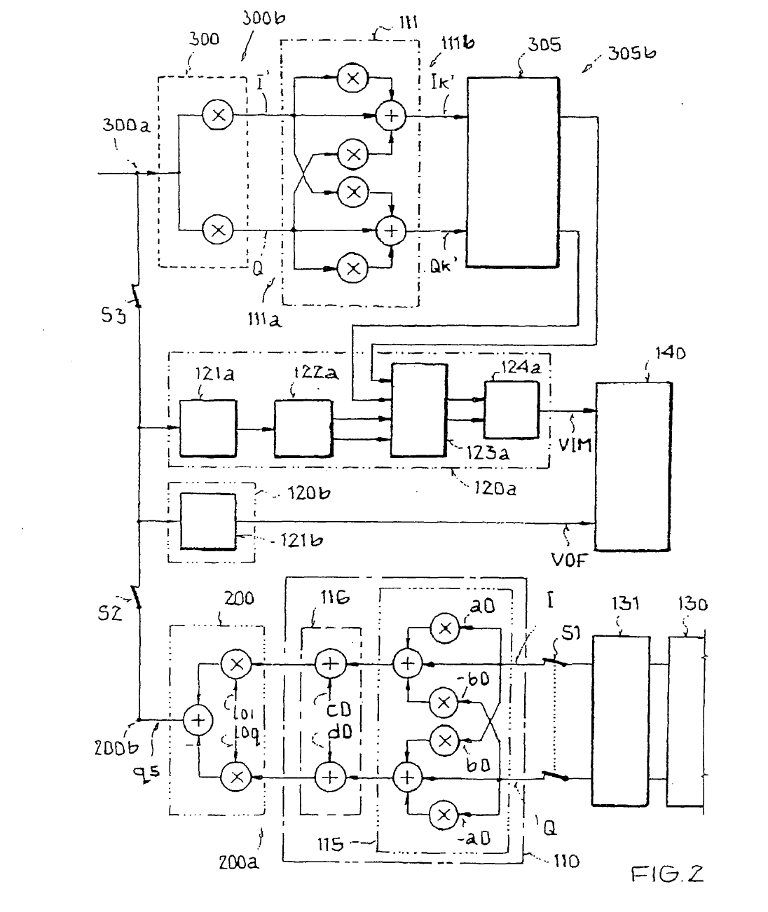

Alternatively, calibration system 100 has its own control unit, which is evident from the detailed view of FIG. 2, described in greater detail below, and is provided with the reference character 140.

In addition to the components, of calibration system 100 of the invention, as already described with reference to FIG. 1, a filter 131, which is described in greater detail below, is evident from FIG. 2 and is connected to test signal generator 130.

The output of filter 131 can be connected via the already described switch S1, which like the additional switches S2, S3 can be controlled via control unit 140, to correction device 110 of the invention and this supplies with closed switch S1 a test signal filtered through filter 131, which is called the complex input signal I, Q hereafter.

Correction device 110 converts the complex input signal I, Q supplied to it and outputs it in the form of a corrected signal Ik, Qk (cf. FIG. 1) to the quadrature modulator 200 to be calibrated.

On the output side, quadrature modulator 200, as already described with reference to FIG. 1, can be connected via a second switch S2 to now two feedback branches 120a, 120b, whose components are surrounded by a dash-dot line in FIG. 2.

The variant of the calibration system of the invention, as shown in FIG. 2, furthermore has a third switch S3, by which output 200b of quadrature modulator 200 can also be connected to an input 300a of a quadrature demodulator 300.

Quadrature demodulator 300 is located, for example, in a receiving branch of a transceiver, which also has the already described quadrature modulator 200.

In analogy to correction device 110, assigned to quadrature modulator 200 on the input side, a second correction device 111 is assigned to quadrature demodulator 300 on the output side. Second correction device 111 is followed by a filter 305, which is preferably a bandpass filter, which is used for selecting a certain frequency band of the output signal supplied by quadrature demodulator 300.

A filtered output signal, available on the output side at filter 305, is supplied to multiplexer 123a of first feedback branch 120a in calibration system 100 of the invention. It is possible in this way to select alternatively either a quadrature signal qs, processed by components 121a, 122a, of quadrature modulator 200 or the filtered output signal of filter 305 for further signal processing in feedback branch 120a. Multiplexer 123a is controlled by control unit 140.

As is evident from FIG. 2, first correction device 110 has a first correction unit 116 and a second correction unit 115.

First correction unit 116 in the present case comprises two adders, whereby each adder enables the addition of a component I, Q, processed by correction unit 116, of the complex signal with a parameter c0, d0 assigned to the specific component. The parameters c0, d0 can be predefined by control unit 140. First correction unit 116 of correction device 110 thereby enables an offset adjustment of the complex signal supplied to quadrature modulator 200. The offset adjustment can be used in particular to reduce the local oscillator leakage effect.

The second correction unit 115 is a functional block, which makes it possible to influence a phase and/or amplitude of the processed complex signal I, Q. For example, each part, assigned to a component I, Q of the complex signal, of second correction unit 115 has two multipliers and one adder, which are used to create a complex output signal of second correction unit 115 depending on the complex input signal I, Q supplied to it.

The multipliers, as is evident from FIG. 2, perform a multiplication of the input values, assigned to them, by the factors −a0, −a0, −b0, b0, whereas the adder adds the three input signals assigned to it, to obtain the corresponding output signal.

Proceeding from a determined input signal I1, Q1, an output signal I2 is obtained in this way at the output of second correction unit 115, for which the following applies:
I2=I1(1+a0)−b0·Q1,

The following results by analogy for output signal Q2, corresponding to the quadrature component, of second correction unit 115:
Q2=Q1(1−a0)+b0·I1.

Overall, a distortion of input signal I, Q can be achieved by second correction unit 115; this distortion can be interpreted as a rotation, extension, and/or rotation/extension of a complex number or a point in the complex plane, which represents a specific signal value of the complex signal I, Q.

Possibly present asymmetries in quadrature modulator 200 and in the additional signal-processing components of a transmitting path of the transceiver in quadrature modulator 200 can be compensated by suitable selection of parameters a0, b0.

In addition to the structure of correction unit 115, shown as an example in FIG. 2, other embodiments are also conceivable, which permit suitable distortion of the complex signal I, Q and thereby compensation of interference quantities.

Functional block 111, assigned to quadrature demodulator 300, is designed like second correction device 115 of quadrature modulator 200; i.e., contrary to first correction device 110, quadrature demodulator 300 has no offset correction unit 116 assigned to it.

First feedback branch 120a of calibration system 100 of the invention has on the input side an amplitude detector 121a, which as already described can be connected via switch S2 to output 200b of quadrature modulator 200. Amplitude detector 121a preferably is a linear amplitude detector, which, for example, is realizable as a semiconductor diode and an ohmic resistor connected in series for this purpose.

Amplitude detector 121a produces a corresponding envelope signal from quadrature signal qs supplied to it on the input side.

As is evident from FIG. 2, the envelope signal is then supplied to bandpass filter 122a, which selects an interesting frequency range of the envelope signal and relays it to the already described multiplexer 123a. Multiplexer 123a is followed by another detector which is preferably a logarithmic amplitude detector 124a. Logarithmic amplitude detector 124a forms from the input signal supplied to it by multiplexer 123a an appropriate output signal, also called a feedback signal VIM, which is supplied to control unit 140 for evaluation.

In addition to first feedback branch 120a, another feedback branch 120b is provided in the variant of calibration system 100 of the invention shown in FIG. 2. Second feedback branch 120b has a preferably logarithmic amplitude detector 121b, which can be connected in the already described manner also via second switch S2 to output 200b of quadrature modulator 200. Amplitude detector 121b performs an envelope detection of the quadrature signal qs and relays an envelope signal, obtained therefrom, as a feedback signal VOF also for evaluation to control unit 140.

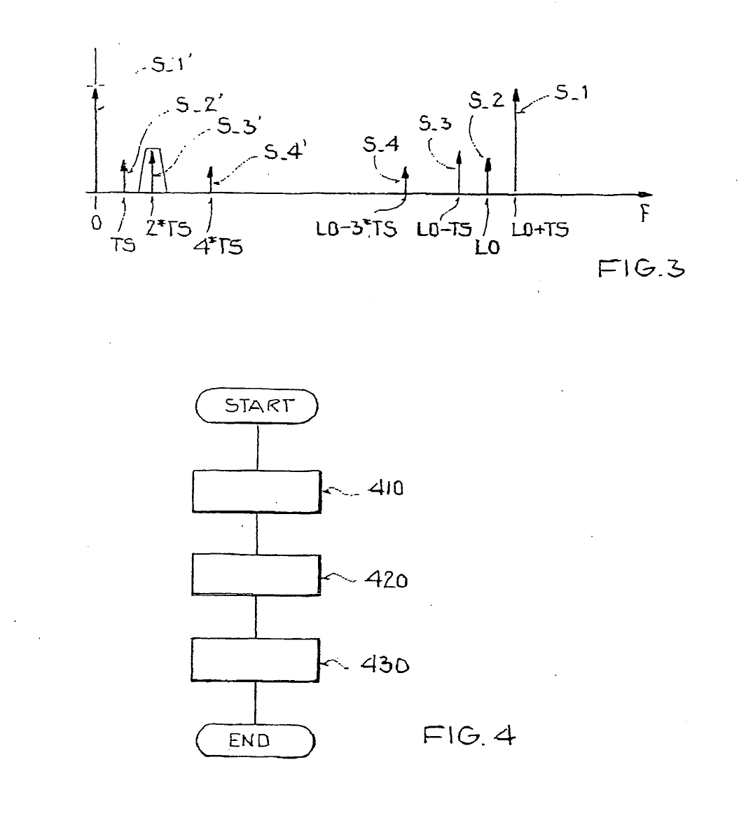

The calibration method of the invention is described in greater detail below with reference to the flow diagram provided in FIG. 4.

In a first step 410 of the calibration method of the invention, first an adjustment process is performed, the object of which is an offset adjustment by first correction unit 116.

No modulating signal is supplied to quadrature modulator 200 for the offset adjustment of first correction unit 116. This can be effected, for example, in that test signal generator 130 outputs no test signal or complex input signal I, Q. Alternatively, for this purpose, controllable switch S1 can also be set by control unit 140 to a switching state in which correction device 110 is connected neither to test signal generator 130 or its filter 131 nor is still connected to a wanted signal source.

In this situation, a signal, unwanted per se, is applied at an input 200a of quadrature modulator 200 if necessary; this signal arises because of, e.g., a capacitive coupling between local oscillator (not shown) of quadrature modulator 200 or the corresponding local oscillator signal inputs loi, loq of quadrature modulator 200 and input 200a for the wanted signal and accordingly has the same frequency as the signal of the local oscillator.

The unwanted signal at input 200a is accordingly modulated by quadrature modulator 200, as a result of which a quadrature signal, which has a carrier signal, arises at output 200b of quadrature modulator 200. The carrier signal is a measure for the overcoupling of the local oscillators signal at input 200a and is detected by logarithmic amplitude detector 121b of feedback branch 120b and is relayed in the form of the feedback signal VOF to control unit 140. Control unit 140 thereupon changes the parameters c0, d0 of offset correction unit 116 in such a way that the described constant component becomes minimal. In this state, a best possible compensation of the local oscillator leakage effect can be assumed.

In general, either a value of zero is assumed or set or a previously determined better value for the offset adjustment of first adjustment process 410 for parameters a0, b0 of second correction unit 115.

After first adjustment process 410, another adjustment process is performed according to the invention as a second step 420 (FIG. 4), in which parameters a0, b0 of second correction unit 115 are successively changed and the resulting feedback signals of the two feedback branches 120a, 120b are evaluated by control unit 140.

It is possible in particular by modifying parameters a0, b0 to largely eliminate an unwanted second frequency band, arising due to asymmetries in quadrature modulator 200, within the quadrature signal. For this purpose, second correction unit 116 is preferably operated with parameters c0, d0 determined previously in first adjustment process 410.

Further details on the second adjustment process 420 are provided below with reference to the spectra shown in FIG. 3.

A first spectral line s_1 represents hereby a test signal generated by test signal generator 130 (FIG. 2) or the test signal filtered accordingly by filter 131. A spectral line s_2 is also shown in FIG. 3, which corresponds to a carrier signal formed by the local oscillator signal and accordingly is plotted at the frequency LO. Because of the quadrature modulation of the test signal, its spectral line s_1 is located at a frequency distance TS from the frequency LO of the local oscillator signal, i.e., at a frequency LO+TS.

A frequency band unwanted per se or signal s_3 is found at the frequency LO−TS, as is evident from FIG. 3. In this case, this is an image frequency which belongs to the test signal and which occurs because of asymmetries in quadrature modulator 200 or because of other interfering effects.

Also shown in, FIG. 3 is a spectral line s_4, which is provided as representative for nonlinear distortions in the quadrature modulator and is plotted at the frequency LO−3*TS, but is described in greater detail below.

In addition to the four previously discussed spectral lines s_1 to s_4, which result in quadrature modulation of the test signal by real quadrature modulator 200, and of which spectral line s_1 alone, corresponding to the wanted sideband, is to be processed further and in particular to be transmitted, FIG. 3 also shows additional spectral lines s_1′ to s_4′, as are obtained in envelope demodulation of the quadrature signal qs, and which correspond to spectral lines s_1 to s_4 of the quadrature signal.

In other words, a signal, which has the four additional spectral lines s_1′ to s_4′ in a frequency range from 0 to 4*TS, is applied at the output of amplitude detector 121a.

The feedback branch 120a of the invention is provided to optimize the process of quadrature modulation particularly in regard to suppression of the unwanted sideband s_3 in the image frequency position, i.e., at the frequency LO−TS. According to the previously described envelope modulation, the spectral line s_3′, corresponding to the image frequency, is selected advantageously at the frequency 2*TS from the envelope signal in feedback branch 120a by bandpass filter 122a and relayed by multiplexer 123a to the additional amplitude detector 124a. The additional amplitude detector 124a forms a feedback signal VIM from this, whose value is proportional to the amplitude of spectral line s_3′; i.e., the feedback signal VIM represents a measure for image frequency suppression.

During evaluation of the feedback signal VIM, control unit 140 finally changes parameters a0, b0 of second correction unit 115 until the feedback signal VIM is minimal, i.e., until an optimal image frequency suppression is assured.

In addition to a selection of parameters a0, b0 with respect to maximum image frequency suppression, the amplitude of test signal generator 130 can be selected as sufficiently large, because the possibly arising nonlinear distortions in quadrature modulator 200, cf., e.g., the spectral line s_4, are suppressed in bandpass filter 122a.

Like parameters c0, d0 of second correction unit 116, the determined parameters a0, b0 of first correction unit 115 are stored, for example, in a nonvolatile memory (not shown) of control unit 140. After the calibration of the invention has ended, these parameters can be used during normal operation of quadrature modulator 200; as a result, a minimal local oscillator leakage effect and maximum image frequency suppression are assured.

As soon as the first two adjustment processes 410, 420 have been successfully completed, a calibration of quadrature demodulator 300 occurs in another step 430, cf. FIG. 4. For this purpose, controllable switch S3 is closed by control unit 140, so that quadrature demodulator 300 is supplied on the input side with the modulated test signal outputted by quadrature modulator 200.

An accordingly demodulated complex output signal I′, Q′ is received at an output 300b of quadrature demodulator 300 and supplied to the already described second correction unit 111 at its input 111a.

During the third calibration step 430, the parameters of second correction unit 111 are successively changed by control unit 140, as well as parameters a0, b0 of second correction unit 115 of first correction device 110, in order to achieve the predetermined adjustment target.

The achieving of the adjustment goal can be advantageously monitored by feedback branch 120a, which has already been used for the adjustment of quadrature modulator 200 in regard to image frequency suppression. For this purpose, multiplexer 123a is set, for example, by control unit 140 such that it relays the signal, available at output 305b of filter 305, to amplitude detector 124a, which in turn outputs its output signal as the feedback signal VIM to control unit 140.

The signal available at output 305b of filter 305 is a corrected complex output signal Ik′, Qk′, which is formed by correction unit 111 and is bandpass-filtered in addition by filter 305. Filter 305 preferably can be configured such that its center frequency lets through as desired an upper or lower sideband of the demodulated test signal or a received signal. Suitable selection of the center frequency within the range of the specifically unwanted image frequency can assure that amplitude detector 124a is supplied only with the spectral portions that correlate with the unwanted image frequency. In this case, the adjustment goal is in turn the minimization of the feedback signal VIM.

In general, the aforementioned process and adjustment steps 410, 420, 430 can also be performed one after another or different frequencies for center frequencies of the complex test signal outputted by test signal generator 130, to enable an adjustment of quadrature modulator 200 and of quadrature demodulator 300 for different frequencies. In this case, a suitable set of parameters for correction devices 110, 111 is obtained for each of the analyzed frequency ranges.

Although calibration system 100 of the invention can be used especially advantageously for calibrating quadrature modulators 200 and quadrature demodulators 300, and because of the multiple utilization of feedback branches 120a with use of multiplexer 123a, only a minimal expenditure is required for calibrating both components 200, 300, instead, e.g., of only one quadrature modulator 200, it is also possible to lay out calibration system 100 solely for the calibration of a quadrature modulator 200. In this case, multiplexer 123a and the additional amplitude detector 124a, as well as switch S3 and second correction unit 111, are not necessary.

Filter 131 is used primarily for increasing the quality of the test signals and can also be eliminated.

It is further conceivable to provide additional feedback branches, which make possible either an evaluation of different frequency ranges or also the simultaneous evaluation of parameters influencing the operation of a quadrature modulator 200 and a quadrature demodulator 300.

The calibration system 100 of the invention can be advantageously integrated into existing integrated transceiver circuits.

In a very advantageous variant of the invention, filters, particularly bandpass filters with a different center frequency, are provided in at least one feedback branch 120a, of which one in each case can be switched via a corresponding switch in feedback branch 120a. Alternatively, a bandpass filter with a controllable center frequency can also be provided.

The invention overall enables an especially efficient calibration of a quadrature modulator 200 and/or quadrature demodulator 300. In transceivers, which depending on the operating mode use, e.g., a lower and an upper sideband, a complete calibration can be done by the system 100 of the invention especially advantageously in that the offset adjustment of quadrature modulator 200 according to step 410 is carried out first for the first or upper sideband. Next, a calibration of second correction unit 115 occurs with use of a corresponding test signal, whose signal frequencies are within the upper sideband, in order to achieve an optimal image frequency suppression of the lower sideband. Here, parameters c0, d0 previously determined in the offset adjustment 410 are used.

Then, again without a test signal, for the second sideband, i.e., the lower sideband in the present example, the offset adjustment of quadrature modulator 200 is carried out according to step 410, whereby another set of parameters c0, d0 is determined. Next, another calibration of the second correction unit 115 occurs with use of another test signal, whose signal frequencies are within the lower sideband, in order to achieve an optimal image frequency suppression of the upper sideband. Here, the parameters previously determined in the offset adjustment 410 are used analogously. The parameters determined in the additional calibration of second correction unit 115 are stored for later operation.

In a following adjustment step, finally quadrature demodulator 300 is adjusted, whereby in turn suitable test signals are created by test signal generator 130 and relayed via closed switch S3 to quadrature demodulator 300. As in the adjustments steps of quadrature modulator 200, the adjustment of quadrature demodulator 300 for different frequencies such as, e.g., the two sidebands, can also occur separately, whereby corresponding sets of parameters for correction unit 111 are obtained. In the adjustment of quadrature demodulator 300, the parameters determined in each case previously for the operation of quadrature modulator 200 are used advantageously.

The previously described sequence of adjustment steps according to the invention assures that the adjustment of quadrature demodulator 300 occurs with an already adjusted quadrature modulator 200 and thereby as precisely as possible. As a result, furthermore, relatively few adjustments steps are required overall, so that the adjustment according to the invention also proceeds relatively rapidly.

Another advantage in the aforementioned sequence of adjustment steps is that the different adjustment steps have the smallest possible mutual effect.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A system for calibrating at least one quadrature modulator, the system comprising:
a first correction device connectable ahead of the quadrature modulator on an input side for converting a complex input signal into a corrected complex input signal; and
a feedback branch connectable to an output of the quadrature modulator and has an amplitude detector; and
a test signal generator connectable ahead of the first correction device on the input side is provided for providing predetermined test signals,
wherein the feedback branch includes a filter.

2. The system according to claim 1, wherein at least one additional feedback branch connectable to the output of the quadrature modulator is provided, the additional feedback branch having an amplitude detector and/or a filter device.

3. The system according to claim 1, wherein the filter is selectively switchable into or out of the feedback branch.

4. The system according to claim 1, wherein the amplitude detector is designed as a logarithmic amplitude detector.

5. The system according to claim 1, further comprising a control unit to evaluate feedback signals obtained by the feedback branch.

6. The system according to claim 1, further comprising a second correction device whose input is connectable to an output of a quadrature demodulator and whose output is connectable to a filter assigned to the quadrature demodulator, and which is provided for converting a complex output signal of the quadrature modulator into a corrected complex output signal.

7. The system according to claim 6, wherein an output of the filter assigned to the quadrature demodulator is operatively connected to one of the feedback branches.

8. The system according to claim 7, wherein at least one of the feedback branches has a multiplexer to selectively connect an output of an amplitude detector or filter of the respective feedback branch or the output of the filter assigned to the quadrature demodulator to an additional amplitude detector of the feedback branch.

9. The system according to claim 8, wherein the additional amplitude detector is designed as a logarithmic detector.

10. The system according to claim 6, wherein the first and/or second correction device has a first correction unit for correcting an offset of at least one component of the complex input signal or output signal.

11. The system according to claim 6, wherein the first and/or second correction device has a second correction unit for influencing a phase and/or amplitude of the complex input signal or output signal.

12. The system according to claim 6, wherein parameters of the first and/or second correction device are set by a control unit, wherein the setting of the parameters occurs as a function of feedback signals, which is determined by the feedback branch.

13. The system according to claim 1, further comprising a filter for filtering the test signals provided by the test signal generator.

14. A method for operating a system for calibrating at least one quadrature modulator with a correction device, connectable ahead of the quadrature modulator on an input side, for converting a complex input signal into a corrected complex input signal, wherein the quadrature modulator in a first adjustment process is not supplied with an input signal, and wherein during the first adjustment process at least one parameter of a first correction unit provided in the correction device for correcting an offset of at least one component of the complex input signal is set so that an envelope signal, detected by an amplitude detector of the quadrature signal outputted by the quadrature modulator at an output, falls below a predetermined threshold value, wherein a second adjustment process that follows the first adjustment process comprises:
outputting a test signal with a predetermined first frequency or center frequency by a test signal generator as a complex input signal to the correction device;
determining an envelope signal of the quadrature signal, produced from the test signal, by an amplitude detector, which is provided in a feedback branch connectable to the output of the quadrature modulator;
filtering the determined envelope signal;
evaluating the filtered envelope signal by a control unit; and
setting at least one parameter of a second correction unit, provided in the correction device, for influencing a phase and/or amplitude of the complex input signal so that the filtered envelope signal falls below a predetermined threshold value.

15. The method according to claim 14, wherein during the second adjustment process (420), preferably several test signals are outputted one after another, each with a different frequency or center frequency, and that a corresponding set of parameters (a0, b0) is determined for each frequency.

16. The method according to claim 14, wherein the filtering of the envelope signal includes bandpass filtering, wherein a center frequency is selected for the bandpass filtering, which is within the range of the double frequency or center frequency of the employed test signal.

17. The method according to claim 14, further comprising an additional adjustment process comprising:
supplying the quadrature signal formed from the test signal to a quadrature demodulator, wherein a demodulated test signal is received as an output signal at an output of the quadrature demodulator;
formatting a corrected demodulated test signal by a second correction unit assigned to the quadrature demodulator for influencing a phase and/or amplitude of the demodulated test signal;
determining an envelope signal of the corrected demodulated test signal by an amplitude detector,
evaluating the determined envelope signal by the control unit;
setting at least one parameter of the second correction unit so that the determined envelope signal falls below a predetermined threshold value.

18. The method according to claim 17, wherein the control unit is supplied alternatively with a filtered envelope signal of the quadrature modulator or the corrected demodulated test signal of the quadrature demodulator by a multiplexer provided in the feedback branch.

19. The method according to claim 18, wherein an output signal of the multiplexer is supplied to a logarithmic amplitude detector in order to obtain therefrom a feedback signal for evaluation by the control unit.

20. The system according to claim 1, wherein the filter is a bandpass filter.
